(19) United States
(12) Patent Application Publication
(10) Pub. No.: US 2018/0217372 A1
(43) Pub. Date: Aug. 2, 2018

(54) ROTARY DRIVE APPARATUS AND MANUFACTURING METHOD FOR ROTARY DRIVE APPARATUS

(71) Applicant: Nidec Corporation, Kyoto (JP)

(72) Inventor: Junya MIZUKAMI, Kyoto (JP)

(21) Appl. No.: 15/663,882

(22) Filed: Jul. 31, 2017

(30) Foreign Application Priority Data
Jan. 27, 2017 (JP) 2017-012934

(51) Int. Cl. G02B 26/10

(52) U.S. Cl. CPC G02B 26/105

(57) ABSTRACT

This rotary drive apparatus is arranged to rotate a mirror arranged to reflect incoming light coming from a light source, and includes a motor including a rotating portion arranged to rotate about a central axis extending in a vertical direction; and a flywheel including the mirror, and arranged to rotate while being supported by the motor. The flywheel further includes a tubular upper support member, and a lower support member having at least a portion thereof arranged below the upper support member. The mirror has at least a portion thereof arranged on the central axis, and is fixed while being in contact with at least a portion of a lower surface of the upper support member and at least a portion of an upper surface of the lower support member.

### CROSS REFERENCE TO RELATED APPLICATIONS

This application claims the benefit of priority to Japanese Patent Application No. 2017-012934 filed on Jan. 27, 2017. The entire contents of this application are hereby incorporated herein by reference.

### BACKGROUND OF THE INVENTION

### 1. Field of the Invention

The present invention relates to a rotary drive apparatus and a manufacturing method for a rotary drive apparatus.

### 2. Description of the Related Art

A known scanner apparatus used for position recognition in combination with a head-mounted display (HMD) or the like typically has installed therein a mirror arranged to reflect incoming light coming from a light source, and a light guide member arranged to guide the incoming light and reflected light. Such a known optical apparatus including a mirror and a light guide member is described in, for example, JP-A 2010-021105.

In the optical apparatus described in JP-A 2010-021105, a reflecting surface arranged to reflect illuminating light coming from a light source, and the light guide member, which is arranged to guide the illuminating light, are defined by a single monolithic member. In addition, the light guide member is fixed to a base. Therefore, depending on precision of the light guide member, the position and angle of the reflecting surface may be changed, which may affect emission of reflected light from the reflecting surface.

### SUMMARY OF THE INVENTION

A rotary drive apparatus according to a preferred embodiment of the present invention is arranged to rotate a mirror arranged to reflect incoming light coming from a light source, and includes a motor including a rotating portion arranged to rotate about a central axis extending in a vertical direction; and a flywheel including the mirror, and arranged to rotate while being supported by the motor. The flywheel further includes a tubular upper support member, and a lower support member having at least a portion thereof arranged below the upper support member. The mirror has at least a portion thereof arranged on the central axis, and is fixed while being in contact with at least a portion of a lower surface of the upper support member and at least a portion of an upper surface of the lower support member.

According to the above preferred embodiment of the present invention, the mirror, which is arranged to reflect the incoming light, is held and fixed between the upper support member and the lower support member, which are arranged above and below, respectively, the mirror. This contributes to preventing a displacement of the mirror, and to securely fixing the mirror.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a rotary drive apparatus, a light source, and a frame according to a first preferred embodiment of the present invention.

FIG. 2 is a perspective sectional view of the rotary drive apparatus according to the first preferred embodiment.

FIG. 3 is a vertical sectional view of the rotary drive apparatus according to the first preferred embodiment.

FIG. 4 is an exploded perspective view of a flywheel according to the first preferred embodiment.

FIG. 5 is a perspective view of a mirror according to the first preferred embodiment.

FIG. 6 is a perspective view of an upper support member and an upper outer cylindrical portion according to the first preferred embodiment.

FIG. 7 is a bottom view of the upper support member and the upper outer cylindrical portion according to the first preferred embodiment.

FIG. 8 is a perspective view of a lower support member and a lower outer cylindrical portion according to the first preferred embodiment.

FIG. 9 is a perspective view of an upper support member and an upper outer cylindrical portion according to a modification of the first preferred embodiment.

FIG. 10 is a perspective view of a lower support member and a lower outer cylindrical portion according to a modification of the first preferred embodiment.

### DETAILED DESCRIPTION OF THE PREFERRED EMBODIMENTS

Hereinafter, preferred embodiments of the present invention will be described with reference to the accompanying drawings. It is assumed herein that a direction parallel to a central axis of a motor, which will be described below, is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a light source is arranged with respect to the motor is defined as an upper side. The shape of each member or portion and relative positions of different members or portions will be described based on the above assumptions. It should be noted, however, that the above definitions of the vertical direction and the upper side are not meant to restrict in any way the orientation of a rotary drive apparatus according to any preferred embodiment of the present invention when in use. Also note that the term “parallel” as used herein includes both “parallel” and “substantially parallel”. Also note that the term “perpendicular” as used herein includes both “perpendicular” and “substantially perpendicular”.

### 1. First Preferred Embodiment

### 1-1. Structure of Rotary Drive Apparatus

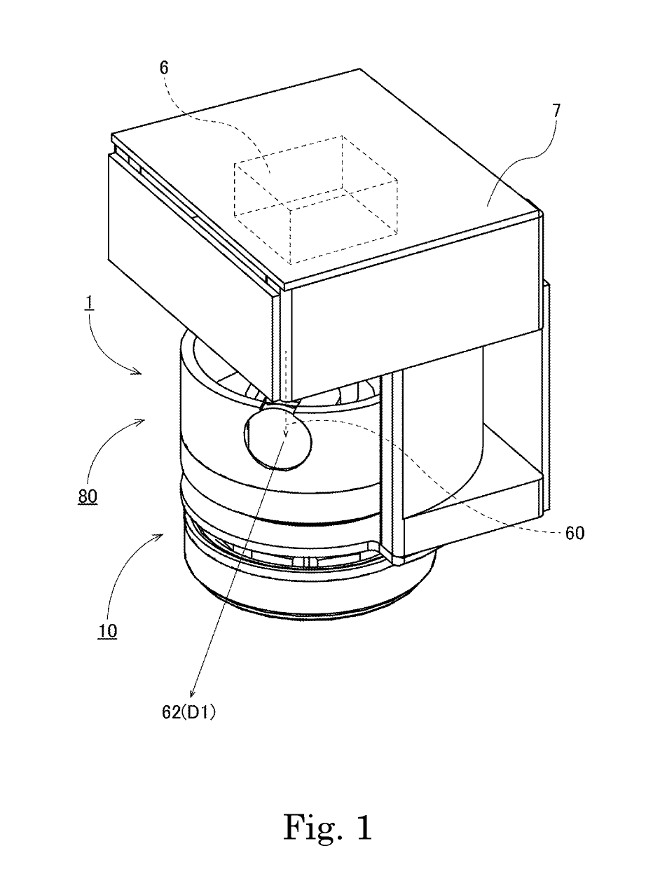

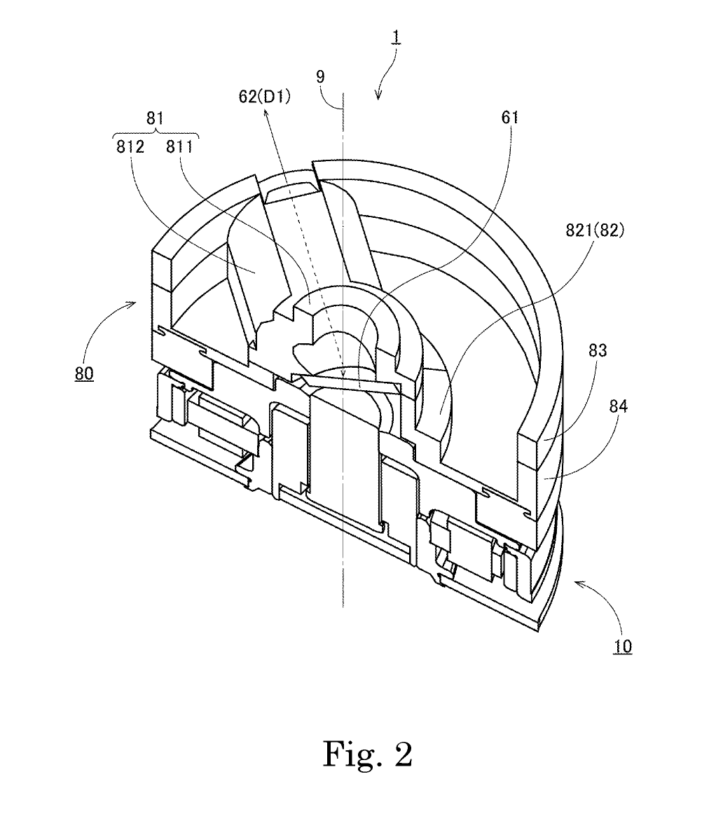

FIG. 1 is a perspective view of a rotary drive apparatus 1, a light source 6, and a frame 7 according to a first preferred embodiment of the present invention. FIG. 2 is a perspective sectional view of the rotary drive apparatus 1 according to the first preferred embodiment taken along a plane including a central axis 9. The rotary drive apparatus 1 is an apparatus arranged to rotate a mirror 61, which is arranged to reflect incoming light 60 coming from the light source 6 in a radial direction (i.e., a first radial direction D1), and emit reflected light 62 obtained by the mirror 61 reflecting the incoming light 60 to an outside of the rotary drive apparatus 1 through a lens 85, which will be described below, while rotating the mirror 61, which will be described below. The frame 7, in which the light source 6 is installed, is arranged above the rotary drive apparatus 1. The frame 7 is fixed to a case or the like in which the rotary drive apparatus 1 is arranged. The incoming light 60, which travels downward along the central axis 9 of a motor 10, is emitted from the light source 6. In the present preferred embodiment, the light source 6 and the frame 7 are arranged outside of the rotary drive apparatus 1. Note, however, that each of the light source 6 and the frame 7 may alternatively be included in the rotary drive apparatus 1.

Referring to FIGS. 1 and 2, the rotary drive apparatus 1 includes the motor 10 and a flywheel 80.

### 1-2. Structure of Motor

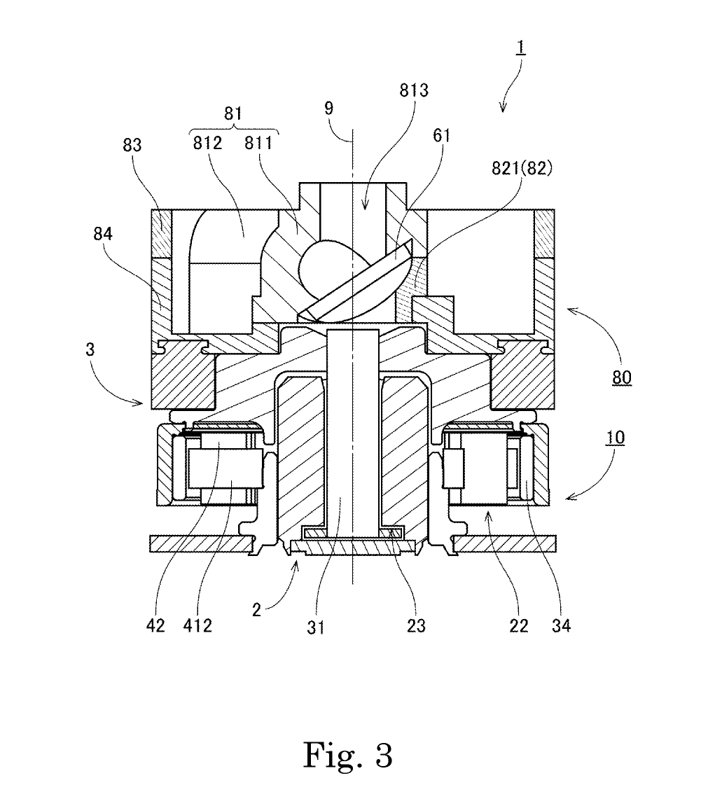

Next, the structure of the motor 10 will now be described below. FIG. 3 is a vertical sectional view of the rotary drive apparatus 1 according to the first preferred embodiment.

Referring to FIG. 3, the motor 10 includes a stationary portion 2 including a stator 22, and a rotating portion 3 including a magnet 34. The stationary portion 2 is arranged to be stationary relative to the case or the like in which the rotary drive apparatus 1 is arranged. The rotating portion 3 is supported through a bearing portion 23 to be rotatable about the central axis 9, which extends in the vertical direction, with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3, so that the rotating portion 3 is caused to rotate about the central axis 9 with respect to the stationary portion 2. Thus, the flywheel 80, which is rotatably held by the rotating portion 3, is caused to rotate about the central axis 9 together with the rotating portion 3.

As the bearing portion 23, a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion 23.

### 1-3. Structure of Flywheel

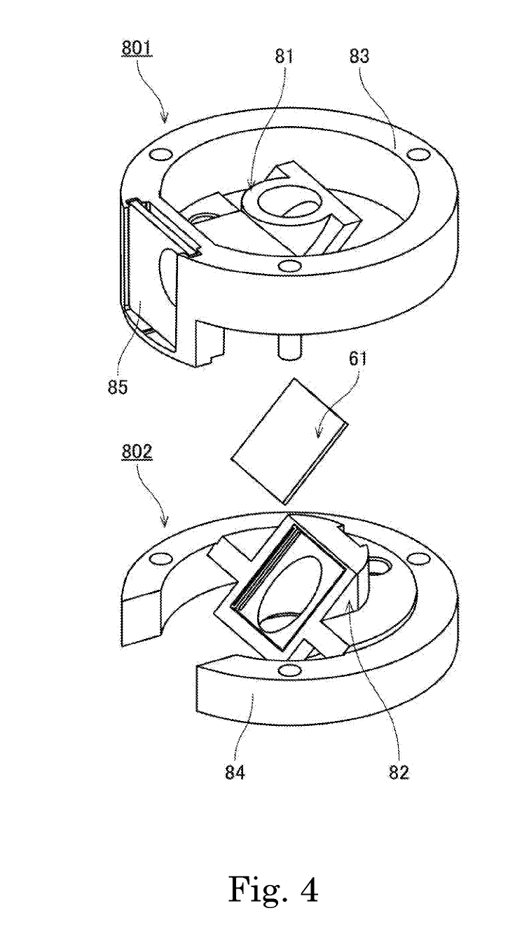

Next, the structure of the flywheel 80 will now be described below. Hereinafter, reference will be made to FIGS. 1 to 3 appropriately as well as FIGS. 4, 5, 6, 7, and 8, which will be described below.

The flywheel 80 is supported by an upper end portion of the rotating portion 3 of the motor 10, and is arranged to rotate about the central axis 9 together with the rotating portion 3. The flywheel 80 is fixed to an upper surface of the rotating portion 3 through, for example, engagement, an adhesive, or the like. The flywheel 80 includes the mirror 61, an upper support member 81, a lower support member 82, an upper outer cylindrical portion 83, a lower outer cylindrical portion 84, and the lens 85. FIG. 4 is an exploded perspective view of the flywheel 80, illustrating a first unit 801 including the upper support member 81 and the upper outer cylindrical portion 83, the mirror 61, and a second unit 802 including the lower support member 82 and the lower outer cylindrical portion 84 separately. Referring to FIG. 4, the mirror 61 is held and fixed between the upper support member 81 and the lower support member 82. A manner in which the mirror 61 is fixed will be described in detail below. A resin, for example, is used as a material of the flywheel 80.

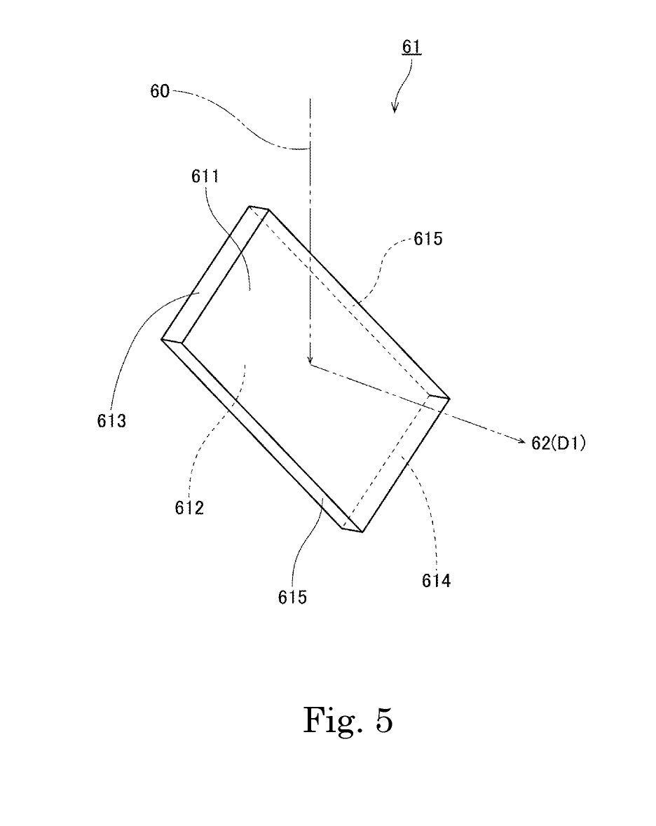

FIG. 5 is a perspective view of the mirror 61 according to the first preferred embodiment. Referring to FIG. 5, the mirror 61 is in the shape of a flat rectangular parallelepiped. In other words, the mirror 61 is in the shape of a rectangular plate. In a situation in which the mirror 61 is fixed to the flywheel 80, at least a portion of the mirror 61 is arranged on the central axis 9. As suggested above, the mirror 61 is fixed while being in contact with at least a portion of a lower surface of the upper support member 81 and at least a portion of an upper surface of the lower support member 82. This contributes to preventing a displacement of the mirror 61, and to securely fixing the mirror 61. A fully reflective mirror, for example, is used as the mirror 61. In addition, the mirror 61 is inclined at an angle of 45° with respect to the axial direction and the first radial direction D1 in the situation in which the mirror 61 is fixed to the flywheel 80. Detailed descriptions will be provided below on the assumption that, in a situation in which the mirror 61 is arranged at an angle in the flywheel 80, the largest surface of the mirror 61 that faces upward is referred to as an upper surface 611, the largest surface of the mirror 61 that faces downward and is opposite to the upper surface 611 is referred to as a lower surface 612, a side surface of the mirror 61 that is arranged on the upper side is referred to as an upper side surface 613, a side surface of the mirror 61 that is arranged on the lower side is referred to as a lower side surface 614, and two side surfaces of the mirror 61 each of which joins the upper side surface 613 and the lower side surface 614 to each other are each referred to as a lateral side surface 615. The incoming light 60 impinges on the upper surface 611.

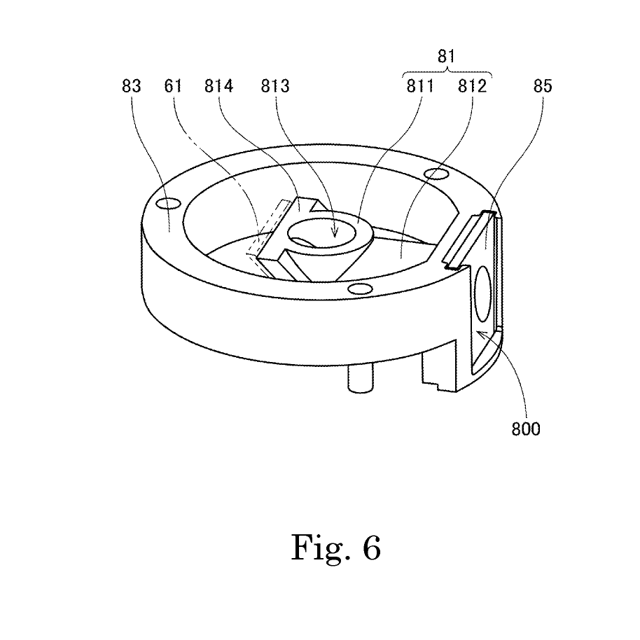

FIG. 6 is a perspective view of the upper support member 81 and the upper outer cylindrical portion 83 according to the first preferred embodiment. Referring to FIG. 6, the upper support member 81 is a tubular member including an upper vertical cylindrical portion 811 and an upper horizontal cylindrical portion 812. In the present preferred embodiment, the upper vertical cylindrical portion 811, the upper horizontal cylindrical portion 812, and the upper outer cylindrical portion 83 are defined as a single monolithic member by a resin injection molding process. Note, however, that the upper vertical cylindrical portion 811, the upper horizontal cylindrical portion 812, and the upper outer cylindrical portion 83 may alternatively be defined by separate members.

The upper vertical cylindrical portion 811 is a cylindrical portion arranged to extend in the axial direction from a radially inner end portion of the upper horizontal cylindrical portion 812. An inner circumferential surface of the upper vertical cylindrical portion 811 is arranged to extend in parallel with the central axis 9 of the motor 10. A cavity 813 radially inside of the upper vertical cylindrical portion 811 is arranged to define a light path.

The upper horizontal cylindrical portion 812 is a cylindrical portion arranged to extend outward in a radial direction (i.e., in the first radial direction D1) from an outer circumferential portion of the upper vertical cylindrical portion 811. A cavity inside of the upper horizontal cylindrical portion 812 is joined to the cavity 813 radially inside of the upper vertical cylindrical portion 811 at right angles. In addition, the cavity inside of the upper horizontal cylindrical portion 812 and the mirror 61 are arranged to overlap with each other when viewed in the first radial direction D1.

Further, the upper support member 81 includes an upper edge support portion 814 arranged to extend outward from a lower end portion of the upper vertical cylindrical portion 811 and a radially inner end portion of the upper horizontal cylindrical portion 812. The upper edge support portion 814 is arranged to be in contact with an edge portion of the upper surface 611 of the mirror 61 in the situation in which the mirror 61 is fixed to the flywheel 80. This contributes to more securely fixing the mirror 61.

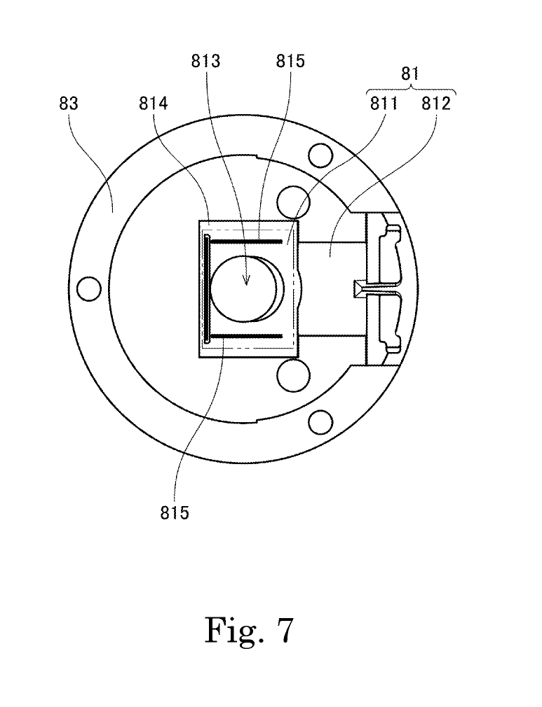

FIG. 7 is a bottom view of the upper support member 81 and the upper outer cylindrical portion 83 according to the first preferred embodiment. A dot-dashed line in FIG. 7 represents the position of the mirror 61. The upper edge support portion 814 includes a lower surface arranged to extend obliquely along the upper surface 611 of the mirror 61. Referring to FIG. 7, the upper edge support portion 814 further includes upper linear projections 815 each of which is arranged to project downward from the lower surface thereof at right angles thereto (or from the lower surface thereof in a direction toward an upper surface of a lower edge support portion 824, which will be described below), and extend in parallel with the lateral side surfaces 615 of the mirror 61. The upper surface 611 of the mirror 61 is fixed while being in contact with at least a portion of each upper linear projection 815. This contributes to preventing the mirror 61 from being displaced in a direction perpendicular to a direction in which the mirror 61 is inserted. It is desirable that the upper linear projections 815 be arranged at end portions of the lower surface of the upper edge support portion 814 on opposite sides of a center line of the upper horizontal cylindrical portion 812, that is, that a total of two or more upper linear projections 815 be provided. This contributes to preventing a displacement of the mirror 61 in a balanced manner. In addition, it is desirable that the upper linear projections 815 be arranged in the vicinity of opposite ends of the lower surface of the upper edge support portion 814. This contributes to further stabilizing the posture of the mirror 61. In a case where a half mirror is used as the mirror 61 to allow a portion of the incoming light 60 to pass through the mirror 61 as described below, a stabilized posture of the mirror 61 contributes to preventing travel of the portion of the incoming light 60 that has passed through the mirror 61 from being affected.

The upper outer cylindrical portion 83 is a cylindrical member arranged to extend along the central axis 9 radially outside of the upper support member 81. An outer circumferential surface of the upper outer cylindrical portion 83 defines a portion of an outer circumferential surface of the flywheel 80. In addition, a through hole 800, which is arranged to pass through the upper outer cylindrical portion 83 in the first radial direction D1, is defined in the upper outer cylindrical portion 83 at one circumferential position. The lens 85, which is arranged to cover a radially outer end portion of the upper horizontal cylindrical portion 812, is fitted and fixed in the through hole 800. In addition, the radially outer end portion of the upper horizontal cylindrical portion 812 is joined to an inner circumferential surface of a portion of the upper outer cylindrical portion 83 which surrounds the through hole 800. The upper outer cylindrical portion 83 and the upper support member 81 are thus joined to each other.

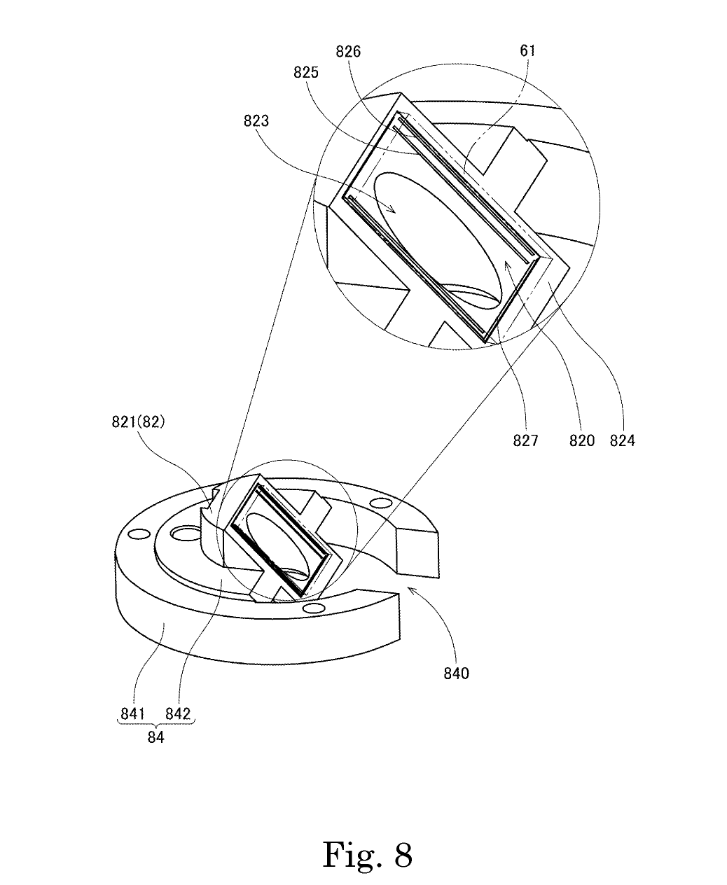

FIG. 8 is a perspective view of the lower support member 82 and the lower outer cylindrical portion 84 according to the first preferred embodiment. Referring to FIG. 8, the lower support member 82 is a tubular member having at least a portion thereof arranged below the upper support member 81. The lower support member 82 includes a lower vertical cylindrical portion 821. The lower vertical cylindrical portion 821 and the lower outer cylindrical portion 84 are defined as a single monolithic member by a resin injection molding process. Note, however, that the lower vertical cylindrical portion 821 and the lower outer cylindrical portion 84 may alternatively be defined by separate members.

The lower vertical cylindrical portion 821 is a cylindrical portion arranged to extend in the axial direction. An inner circumferential surface of the lower vertical cylindrical portion 821 is arranged to extend in parallel with the central axis 9 of the motor 10.

In addition, the lower support member 82 includes a lower edge support portion 824 arranged to extend outward from an upper end portion of the lower vertical cylindrical portion 821. The lower edge support portion 824 is arranged to be in contact with an edge portion of the lower surface 612 of the mirror 61 in the situation in which the mirror 61 is fixed to the flywheel 80. This contributes to more securely fixing the mirror 61. The lower edge support portion 824 includes an upper surface arranged to extend obliquely along the lower surface 612 of the mirror 61. In addition, the upper surface of the lower edge support portion 824 includes a recessed portion 820 recessed downward and having a rectangular cross-section. The lateral side surfaces 615 of the mirror 61 are fitted in the recessed portion 820, and are fixed to at least portions of the lower edge support portion 824 through press fitting. This allows the mirror 61 to be positioned without being significantly affected by precision in dimensions of the recessed portion 820 or of the mirror 61.

The lower edge support portion 824 further includes lower linear projections 825 each of which is arranged to project upward from the upper surface thereof at right angles thereto (or from the upper surface thereof in a direction toward the lower surface of the upper edge support portion 814), and extend in parallel with the lateral side surfaces 615 of the mirror 61. The lower surface 612 of the mirror 61 is fixed while being in contact with at least a portion of each lower linear projection 825. This contributes to preventing the mirror 61 from being displaced in a direction perpendicular to the direction in which the mirror 61 is inserted. It is desirable that the lower linear projections 825 be arranged at end portions of the upper surface of the lower edge support portion 824 on opposite sides of the center line of the upper horizontal cylindrical portion 812, that is, that a total of two or more lower linear projections 825 be provided. This contributes to preventing a displacement of the mirror 61 in a balanced manner. In addition, it is desirable that the lower linear projections 825 be arranged in the vicinity of opposite ends of the upper surface of the lower edge support portion 824. This contributes to further stabilizing the posture of the mirror 61. In the case where a half mirror is used as the mirror 61 to allow a portion of the incoming light 60 to pass through the mirror 61 as described below, a stabilized posture of the mirror 61 contributes to preventing the travel of the portion of the incoming light 60 that has passed through the mirror 61 from being affected.

In addition, at a position at which each of the lateral side surfaces 615 of the mirror 61 is fixed to the recessed portion 820 through press fitting, a lateral side surface linear projection 826 is arranged to project from at least a portion of the lower support member 82 toward the lateral side surface 615 of the mirror 61 and extend in parallel with the lateral side surface 615 of the mirror 61. The lateral side surface 615 of the mirror 61 is arranged to be in contact with the lateral side surface linear projection 826. This contributes to preventing the mirror 61 from being displaced in a lateral direction. It is desirable that the lateral side surface linear projection 826 be arranged at each of two surfaces of the recessed portion 820 to which the two lateral side surfaces 615 of the mirror 61 are fixed through press fitting, that is, that a total of two or more lateral side surface linear projections 826 be provided. This contributes to preventing a lateral displacement of the mirror 61 in a balanced manner.

Further, a lower side surface linear projection 827 is arranged to project from at least a portion of a surface of the recessed portion 820 of the lower support member 82 toward the lower side surface 614 of the mirror 61 and extend in parallel with the lower side surface 614 of the mirror 61. The lower side surface 614 of the mirror is arranged to be in contact with at least a portion of the lower side surface linear projection 827. This contributes to preventing the mirror 61 from being displaced in the direction in which the mirror 61 is inserted. Note that the number of lower side surface linear projections 827 may be one or more than one. In addition, it is desirable that at least one of the lower side surface linear projections 827 be arranged to project at right angles from the lowermost one of the surfaces of the recessed portion 820 and extend in parallel with the lower side surface 614 of the mirror 61.

The lower outer cylindrical portion 84 includes a lower outer circumferential portion 841 and a lower joining portion 842. The lower outer circumferential portion 841 is a cylindrical member arranged to extend along the central axis 9 radially outside of the lower support member 82. An outer circumferential surface of the lower outer circumferential portion 841 defines a portion of the outer circumferential surface of the flywheel 80. In addition, the outer circumferential surface of the lower outer circumferential portion 841 and the outer circumferential surface of the upper outer cylindrical portion 83 are arranged to have an equal diameter. The lower joining portion 842 is arranged to extend radially inward from a portion of an inner circumferential surface of the lower outer circumferential portion 841, and is joined to an outer circumferential surface of the lower support member 82. Thus, the lower outer circumferential portion 841, the lower joining portion 842, and the lower support member 82 are joined together.

A lower cut portion 840 in the form of a cut is defined in a portion of the lower outer circumferential portion 841 and a portion of the lower joining portion 842 at one circumferential position. The lower cut portion 840 is arranged to axially and radially overlap with a radially outer portion of the upper horizontal cylindrical portion 812 of the upper support member 81 in the situation in which the mirror 61 is fixed to the flywheel 80. That is, when the mirror 61 is fixed to the flywheel 80, the upper support member 81 and the upper outer cylindrical portion 83 joined to the upper support member 81 are brought closer to the lower support member 82 and the lower outer cylindrical portion 84 joined to the lower support member 82, and the radially outer portion of the upper horizontal cylindrical portion 812 is fitted in the lower cut portion 840.

A method in which the mirror 61 is fixed in the flywheel 80 in a process of manufacturing the rotary drive apparatus 1 will now be described below. First, the mirror 61 is fitted in the recessed portion 820 of the lower support member 82, and is thus press fitted to at least a portion of the lower support member 82. Then, the lower surface 612 of the mirror 61 is brought into contact with at least a portion of the upper surface of the lower support member 82 (i.e., a bottom surface of the recessed portion 820). Next, the upper support member 81 and the upper outer cylindrical portion 83 joined to the upper support member 81 are brought closer to the lower support member 82 with the mirror 61 fitted therein and the lower outer cylindrical portion 84 joined to the lower support member 82, and at least a portion of the upper support member 81 is brought into contact with the upper surface 611 of the mirror 61. At this time, the radially outer portion of the upper horizontal cylindrical portion 812 is fitted in the lower cut portion 840. Further, the upper support member 81 and the lower support member 82 are fixed to each other through press fitting, screwing, or engagement. In addition, the upper outer cylindrical portion 83 and the lower outer circumferential portion 841 are fixed to each other through press fitting, screwing, adhesion, or engagement. The upper outer cylindrical portion 83 and the lower outer circumferential portion 841 are placed one above the other in the axial direction to define an exterior of the flywheel 80.

The mirror 61 is fixed to the lower support member 82 through press fitting as described above, and therefore, the position of the mirror 61 can be adjusted without being significantly affected by the precision in the dimensions of the mirror 61 or of the recessed portion 820, which defines an opening in which the mirror 61 is inserted in the lower support member 82. In addition, the mirror 61 is held and fixed between the upper support member 81 and the lower support member 82, and this contributes to preventing a displacement of the mirror 61 and to securely fixing the mirror 61. Further, the upper support member 81 and the lower support member 82 are fixed to each other through press fitting, screwing, or engagement, and accordingly, the positional relationship between the upper support member 81 and the lower support member 82 can be adjusted even after the mirror 61 is held between the upper support member 81 and the lower support member 82, and therefore, it is easy to correct a displacement therebetween.

The incoming light 60, which is emitted from the light source 6, enters the flywheel 80 structured in the above-described manner from above an upper surface of the flywheel 80, and travels downward along the central axis 9 in the cavity 813 radially inside of the upper vertical cylindrical portion 811. The incoming light 60 is then reflected by the mirror 61, and, further, travels outward in the first radial direction D1 in the cavity inside of the upper horizontal cylindrical portion 812, and is emitted out of the rotary drive apparatus 1 through the lens 85 fitted in the through hole 800.

The mirror 61 of the flywheel 80 is arranged to reflect the incoming light 60 from the light source 6 and emit the reflected light 62 to the outside while rotating about the central axis 9 together with the rotating portion 3 of the motor 10. Thus, a wide range can be irradiated with light. Note that the outer circumferential surface of the flywheel 80 has a reflectivity lower than that of a surface of the mirror 61. This contributes to preventing diffuse reflection of the incoming light 60 from the light source 6.

Note that the rotary drive apparatus 1 may further include, in addition to the flywheel 80 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 80 is reflected in the first radial direction D1 to be emitted to the outside. In addition, a remaining half of the incoming light 60 which impinges on the mirror 61 passes through the mirror 61, and travels downward in a cavity 823 radially inside of the lower vertical cylindrical portion 821. Further, a through hole (not shown) passing through the motor 10 in the axial direction is defined around the central axis 9 in the motor 10. Thus, the portion of the incoming light which has passed through the mirror 61 passes through the through hole and reaches the other flywheel arranged below the motor 10. In this other flywheel, this portion of the incoming light 60 is reflected in the second radial direction to be emitted to the outside.

When light is emitted out in the two different directions, i.e., the first radial direction D1 and the second radial direction, as described above, light beams that are emitted out in the two different directions take different times to reach an object to be irradiated with light while the motor 10 is rotating, and this makes it possible to precisely recognize the three-dimensional position of the object in a space. Note that the other flywheel may alternatively be arranged in a rotary drive apparatus (not shown) other than the rotary drive apparatus 1 including the flywheel 80.

### 2. Example Modifications

While preferred embodiments of the present invention have been described above, it is to be understood that the present invention is not limited to the above-described preferred embodiments.

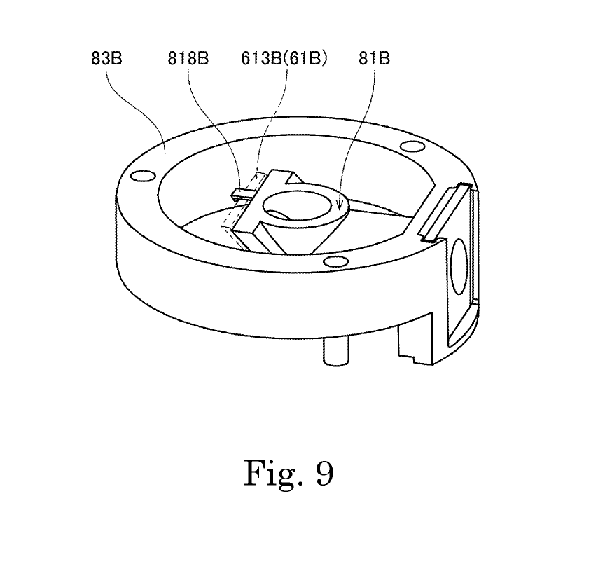

FIG. 9 is a perspective view of an upper support member 81B and an upper outer cylindrical portion 83B according to a modification of the first preferred embodiment. In the modification illustrated in FIG. 9, the upper support member 81B includes a claw portion 818B arranged to project in the direction of a mirror 61B. In a situation in which the mirror 61B is fixed in a flywheel, an upper side surface 613B of the mirror 61B is hooked on the claw portion 818B. This contributes to preventing the mirror 61B from being displaced in a direction in which the mirror 61B is inserted.

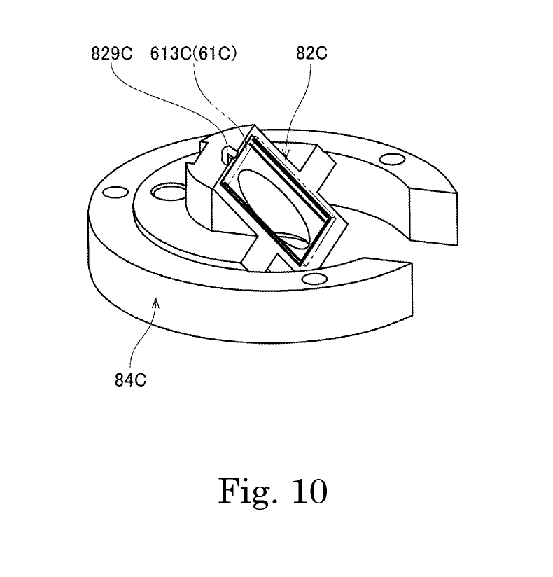

FIG. 10 is a perspective view of a lower support member 82C and a lower outer cylindrical portion 84C according to another modification of the first preferred embodiment. In the modification illustrated in FIG. 10, the lower support member 82C further includes a pressing member 829C arranged to be in contact with an upper side surface 613C of a mirror 61C. In a situation in which the mirror 61C is fixed in a flywheel, the mirror 61C is pressed downward by the pressing member 829C. This contributes to preventing the mirror 61C from being displaced in a direction in which the mirror 61C is inserted.

Note that the detailed shape of any member may be different from the shape thereof as illustrated in the accompanying drawings of the present application. Also note that features of the above-described preferred embodiment and the modifications thereof may be combined appropriately as long as no conflict arises.

Preferred embodiments of the present invention are applicable to, for example, rotary drive apparatuses and manufacturing methods for rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus arranged to rotate a mirror arranged to reflect incoming light coming from a light source, the rotary drive apparatus comprising:
a motor including a rotating portion arranged to rotate about a central axis extending in a vertical direction; and
a flywheel including the mirror, and arranged to rotate while being supported by the motor; wherein
the flywheel further includes:
a tubular upper support member; and
a lower support member having at least a portion thereof arranged below the upper support member; and
the mirror has at least a portion thereof arranged on the central axis, and is fixed while being in contact with at least a portion of a lower surface of the upper support member and at least a portion of an upper surface of the lower support member.

2. The rotary drive apparatus according to claim 1, wherein
the upper support member includes an upper edge support portion arranged to be in contact with an edge portion of an upper surface of the mirror; and
the lower support member includes a lower edge support portion arranged to be in contact with an edge portion of a lower surface of the mirror.

3. The rotary drive apparatus according to claim 2, wherein
the mirror is in a shape of a rectangular plate; and
lateral side surfaces of the mirror are fixed to at least portions of the lower edge support portion through press fitting.

4. The rotary drive apparatus according to claim 2, wherein
the mirror is in a shape of a rectangular plate; and
the upper edge support portion includes two or more upper linear projections each of which is arranged to project from a lower surface thereof in a direction toward an upper surface of the lower edge support portion, and extend in parallel with a lateral side surface of the mirror; and
the upper surface of the mirror is arranged to be in contact with at least a portion of each upper linear projection.

5. The rotary drive apparatus according to claim 2, wherein
the mirror is in a shape of a rectangular plate; and
the lower edge support portion includes two or more lower linear projections each of which is arranged to project from an upper surface thereof in a direction toward a lower surface of the upper edge support portion, and extend in parallel with a lateral side surface of the mirror; and
the lower surface of the mirror is arranged to be in contact with at least a portion of each lower linear projection.

6. The rotary drive apparatus according to claim 2, wherein
the mirror is in a shape of a rectangular plate; and
lateral side surfaces of the mirror are fixed to at least portions of the lower support member through press fitting; and
at a position at which each of the lateral side surfaces of the mirror is fixed, a lateral side surface linear projection is arranged to project from at least a portion of the lower support member toward the lateral side surface of the mirror and extend in parallel with the lateral side surface of the mirror, and the lateral side surface of the mirror is arranged to be in contact with the lateral side surface linear projection.

7. The rotary drive apparatus according to claim 2, wherein
the mirror is in a shape of a rectangular plate; and
a lower side surface linear projection is arranged to project from at least a portion of the lower support member toward a lower side surface of the mirror and extend in parallel with the lower side surface of the mirror; and
the lower side surface of the mirror is arranged to be in contact with at least a portion of the lower side surface linear projection.

8. The rotary drive apparatus according to claim 1, wherein the upper support member and the lower support member are fixed to each other through press fitting, screwing, or engagement.

9. The rotary drive apparatus according to claim 1, wherein
the mirror is in a shape of a rectangular plate; and
the upper support member includes a claw portion arranged to project in a direction of the mirror; and
an upper side surface of the mirror is hooked on the claw portion.

10. The rotary drive apparatus according to claim 1, wherein
the mirror is in a shape of a rectangular plate; and
the lower support member includes a pressing member arranged to be in contact with an upper side surface of the mirror; and
the mirror is pressed downward by the pressing member.

11. A manufacturing method for fixing the mirror in the flywheel of the rotary drive apparatus of claim 1, the manufacturing method comprising the steps of:
a) press fitting the mirror to at least a portion of the lower support member, and bringing a lower surface of the mirror into contact with at least a portion of the upper surface of the lower support member;
b) bringing at least a portion of the upper support member into contact with an upper surface of the mirror; and
c) fixing the upper support member and the lower support member to each other through press fitting, screwing, or engagement.
